(19) United States
(12) Patent Application Publication
(10) Pub. No.: US 2008/0007464 A1
(43) Pub. Date: Jan. 10, 2008

(54) Multi-function antenna apparatus

(76) Inventor: Cho-Kang Hsu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/480,947

(22) Filed: Jul. 6, 2006

(51) Int. Cl. H01Q 1/24

(52) U.S. Cl. 343/702; 343/700 MS

(57) ABSTRACT

A multi-function antenna apparatus utilizes a design having a plurality of paths and can be applied to both a substrate having a grounding layer and a substrate without a grounding layer. The multi-function antenna apparatus includes a body, a main path, a grounding path and a matching-resistance path. The main path is located on an upper surface of the body. The grounding path is located on a lower surface of the body. The matching-resistance path is located on a side surface of the body. The multi-function antenna apparatus of the present invention modifies the matching resistance of the multi-function antenna apparatus by adjusting the capacitance of the capacitor and the inductance of the inductor.

### BACKGROUND OF THE INVENTION

1. Field of the Invention

The present invention relates to a multi-function antenna apparatus. In particular, the antenna can be applied to a substrate having a grounding layer or a substrate without a grounding layer.

2. Description of the Related Art

A wireless local area network uses a public frequency range of the airwaves to transmit data between devices. This frequency range is defined by the FCC and is named ISM. To develop wireless networks APPLE Corporation and other similar companies apply for ISM licenses from the FCC. Wireless LANs can communicate with each other directly without wired devices, just the same as IrDA. Wireless LANs use an AP to connect with an Ethernet router/exchanger or a server and transmit wireless electric wave within several hundred feet to several thousand feet. Such wireless LANs communicate with each other via an antenna having ISM.

FIG. 1 is a schematic diagram of a wireless LAN antenna of the prior art. The antenna is suitable for a PCB 14 having a grounding layer located under the antenna. An antenna loop 10 is located on the upper surface of a body 12. In order to prevent a grounding layer 16 from disturbing the signal of the antenna loop 10, the height of the body 12 must be higher than a predetermined value. Therefore, the antenna is not suitable for a thin or small wireless LAN apparatus.

FIG. 2 is a schematic diagram of another wireless LAN antenna of the prior art. The antenna is suitable for a PCB 26 without a grounding layer located under the antenna or a PCB having a naked area (no PCB) under the antenna. A body 22 is composed of ceramic having multi-layers. An antenna loop is disposed on the multi-layers of the body 22. Although this design can reduce the height of the antenna, it is not suitable for a PCB having a grounding layer located under the antenna.

### SUMMARY OF THE INVENTION

One particular aspect of the present invention is to provide a multi-function antenna apparatus. The multi-function antenna apparatus utilizes a design having a plurality of paths and can be applied to both a substrate having a grounding layer and a substrate without a grounding layer (or a substrate having a naked area).

Another particular aspect of the present invention is to provide a multi-function antenna apparatus. The multi-function antenna apparatus includes a matching-resistance path to adjust the frequency of the antenna apparatus by changing a capacitor or an inductor.

The multi-function antenna apparatus includes a body, a main path, a grounding path and a matching-resistance path. The main path is located on an upper surface of the body. The grounding path is located on a lower surface of the body. The matching-resistance path is located on a side surface of the body.

The multi-function antenna apparatus of the present invention adopts an open design of the antenna path and can be applied to a substrate having a grounding layer and a substrate without a grounding layer. When the antenna apparatus is applied to a wireless communication apparatus with a substrate having a grounding layer, a welding pad is located on the substrate having a grounding layer that corresponds to the antenna path and is used for connecting with the main path.

The multi-function antenna apparatus of the present invention also uses a capacitor and/or an inductor to connect with the main path and the matching-resistance path. By adjusting the capacitance of the capacitor and the inductance of the inductor, the matching resistance of the multi-function antenna apparatus is modified.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of a wireless LAN antenna of the prior art;

FIG. 2 is a schematic diagram of another wireless LAN antenna of the prior art;

FIG. 3 is a schematic diagram of an embodiment of the multi-function antenna apparatus of the present invention;

FIG. 4 is a schematic diagram of the multi-function antenna apparatus of the present invention applied to a PCB having a grounding layer; and

FIG. 5 is a schematic diagram of the multi-function antenna apparatus of the present invention applied to a PCB having a naked area.

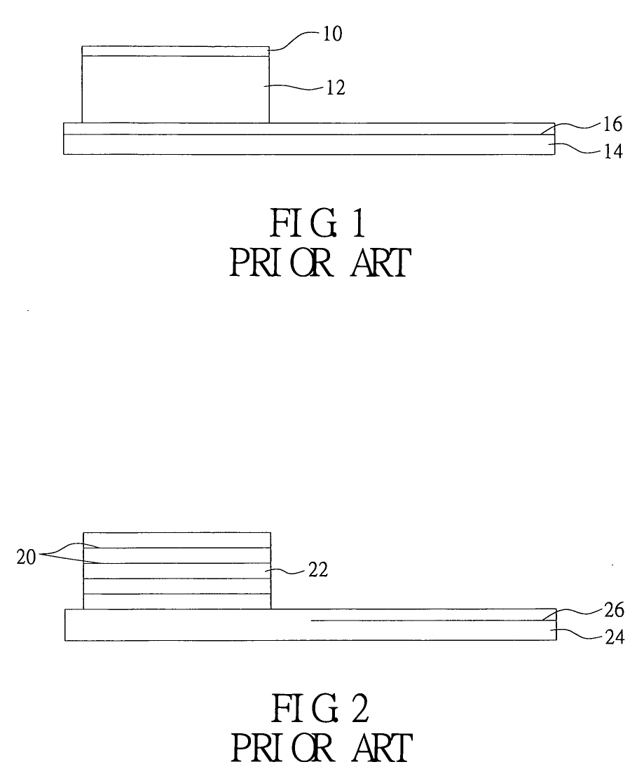

### DETAILED DESCRIPTION OF THE PREFERRED EMBODIMENTS

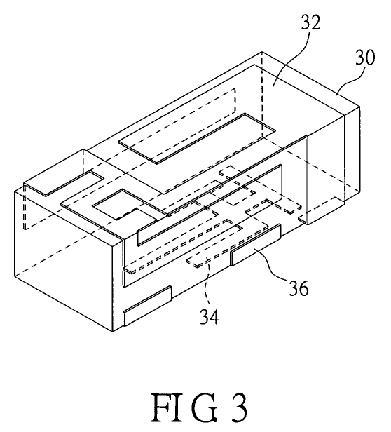

Please refer to FIG. 3, which shows a schematic diagram of an embodiment of the multi-function antenna apparatus of the present invention. The multi-function antenna apparatus of the present invention includes a body 30, a main path 32, a grounding path 34 and a matching-resistance path 36. In this embodiment, the main body 30 is made of ceramic. The main path 32 is located on an upper surface of the body 30. The grounding path 34 is located on a lower surface of the body 30. The matching-resistance path 36 is located on a side surface of the body 30 in order to match with a wireless communication apparatus and its transmitting frequency. Moreover, the main path 32 is located on an upper surface of the body 30, the layout of the main path 32 can extend to a front side surface, a rear side surface, a left side surface and/or a right side surface of the body 30.

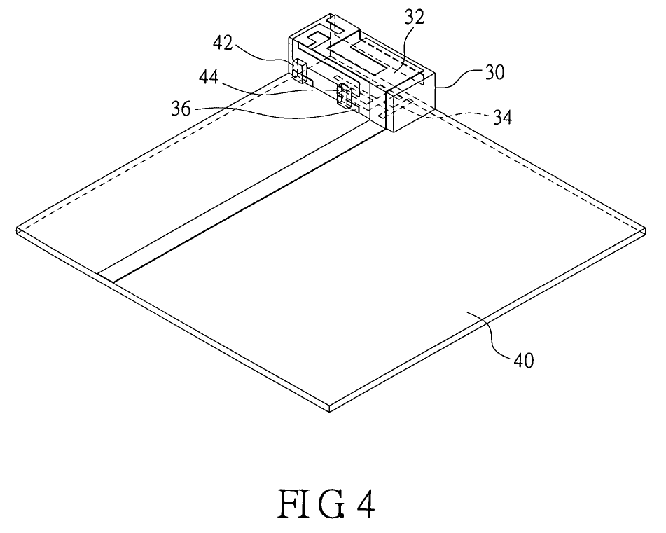

FIG. 4 is a schematic diagram of the multi-function antenna apparatus of the present invention applied to a PCB having a grounding layer. The PCB 40 includes a grounding layer (not shown in the figure), and a welding pad (not shown in the figure) located on the PCB 40 which is under the multi-function antenna apparatus and corresponds to the main path 32 and the grounding path 34. When the multi-function antenna apparatus is installed on the PCB 40, the welding pad makes contact with the main path 32. Furthermore, a capacitor 42 and an inductor 44 are located between the main path 32 and the matching-resistance path 36, and by adjusting the capacitance of the capacitor 32 and the inductance of the inductor 34, the matching resistance of the multi-function antenna apparatus is modified. The number of the capacitor 42 and the inductor 44 depends on the design of the antenna's path and its application. There may be one or more than one antenna.

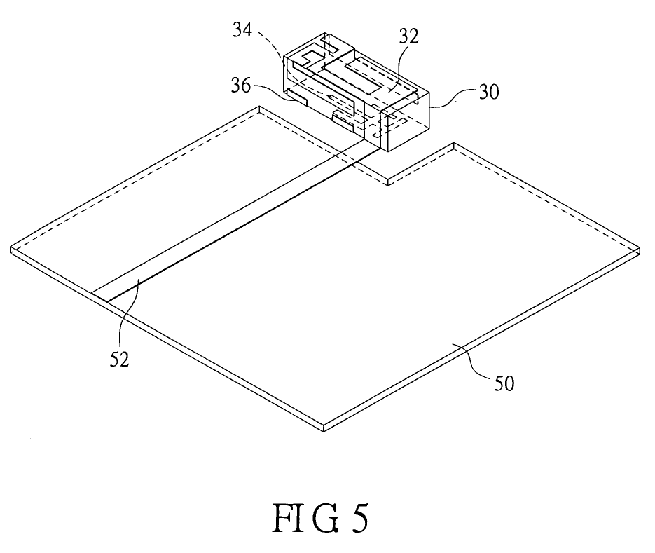

FIG. 5 is a schematic diagram of the multi-function antenna apparatus of the present invention applied to a PCB having a naked area. The multi-function antenna apparatus of the present invention is connected with the main path 32 and the grounding path 34 via a path 52 located on the PCB 50 and communicates signals with other devices.

The multi-function antenna apparatus of the present invention is applied to a wireless communication apparatus capable of operating on a variety of frequencies.

The multi-function antenna apparatus of the present invention has the following characteristics:

1. The multi-function antenna apparatus of the present invention utilizes a design having a plurality of paths and is applied to a substrate having a grounding layer and a substrate without a grounding layer (or a substrate having a naked area).

2. The multi-function antenna apparatus of the present invention modifies the matching resistance of the multi-function antenna apparatus by adjusting the capacitance of the capacitor and the inductance of the inductor.

3. The present invention has an open-path design and increases the flexibility of application.

4. The multi-function antenna apparatus of the present invention provides a single frequency or a multi-frequency function via a plurality of paths.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A multi-function antenna apparatus, comprising:
a body;
a main path, located on an upper surface of the body;
a grounding path, located on a lower surface of the body and having an open-path with the main path; and
a matching-resistance path, located on a side surface of the body.

2. The multi-function antenna apparatus as claimed in claim 1, wherein the body is made of ceramic.

3. The multi-function antenna apparatus as claimed in claim 1, wherein the main path extends to at least one side surface of the body.

4. The multi-function antenna apparatus as claimed in claim 1, further comprising at least one capacitor, connected with the main path and the matching-resistance path.

5. The multi-function antenna apparatus as claimed in claim 1, further comprising at least one inductor, connected with the main path and the matching-resistance path.

6. The multi-function antenna apparatus as claimed in claim 1, further comprising a PCB having a grounding layer, wherein the PCB includes a welding pad that is used for connecting with the main path.

7. A multi-function antenna apparatus, comprising:
a body;
a main path, located on an upper surface of the body; and
a grounding path, located on a lower surface of the body and having an open-path with the main path.

8. The multi-function antenna apparatus as claimed in claim 7, wherein the body is made of ceramic.

9. The multi-function antenna apparatus as claimed in claim 7, wherein the main path extends to at least one side surface of the body.

10. The multi-function antenna apparatus as claimed in claim 7, further comprising a PCB having a grounding layer, wherein the PCB includes a welding pad that is used for connected with the main path.

11. The multi-function antenna apparatus as claimed in claim 7, further comprising a matching-resistance path, located on a side surface of the body.

12. The multi-function antenna apparatus as claimed in claim 11, further comprising at least one capacitor, connected with the main path and the matching-resistance path.

13. The multi-function antenna apparatus as claimed in claim 11, further comprising at least one inductor, connected with the main path and the matching-resistance path.
